(19) United States
(12) Patent Application Publication
(10) Pub. No.: US 2003/0151030 A1
(43) Pub. Date: Aug. 14, 2003

(54) Enhanced conductivity nanocomposites and method of use thereof

(76) Inventor: Michael H. Gurin, Glenview, IL (US)

Correspondence Address: Michael Gurin, 4132 Cove Lane, Unit A, Glenview, IL, 60025, US

(21) Appl. No.: 10/390,393

(22) Filed: Mar. 18, 2003

Related U.S. Application Data
(63) Continuation-in-part of application No. 09/721,074, filed on Nov. 22, 2000, now Pat. No. 6,432,320.

(51) Int. Cl. H01B 1/00; H01B 1/16

(52) U.S. Cl. 252/502; 252/503; 252/506; 252/70; 165/104.11; 165/104.15; 165/104.19

(57) ABSTRACT

An enhanced conductivity nanocomposite having reduced conductivity path directionality dependence as a means for enhancing the electrical and thermal conductivity. The composition comprises a synergistic blend of metal (and their derivatives) and carbon (preferably nanotubes) powder both average particle sizes in the nanometer to micron size range. The carrier medium is selected from the group of interpolymers, polymers, gaseous and liquid fluids, and phase change materials. The synergistic nanocomposite, when mixed with a conductive medium, exhibits enhanced heat transfer capacity, and electrical and thermal conductivity, stable chemical composition, faster heat transfer rates, and dispersion maintenance which are beneficial to most thermal or electrical transfer systems.

### CROSS-REFERENCE TO RELATED APPLICATIONS

This application is a continuation-in-part of U.S. patent application Ser. No. 09/721,074 filed Nov. 22, 2000, included as reference only without priority claims.

### BACKGROUND OF THE INVENTION

The present invention relates to compositions and methods for enhancing the conductivity within a carrier medium. The term “conductivity”, as used herein, includes thermal conductivity, coefficient of thermal heat transfer, and electrical conductivity in a carrier medium.

Heat transfer compositions have applications in both heating and cooling, including refrigeration, air conditioning, computer processors, thermal storage systems, heating pipes, fuel cells, and hot water and steam systems. Heat transfer compositions include a wide range of solids, liquids or phase change materials and the like. For example, liquid or phase change heat transfer materials include water, aqueous brines, alcohols, glycols, ammonia, hydrocarbons, ethers, and various halogen derivatives of these materials, such as chlorofluorocarbons (CFCs), hydrochlorofluorocarbons (HCFCs), and the like. Additives, such as refrigerant oil additives for lubrication and composites of fluids to affect boiling or freezing temperature, have been included in the fluid or phase change materials. Thermal transfer compositions made of solids have been used alone or in combination with additives, such as metal and carbon additives as polymer matrixes for enhanced thermal conductivity. Such media are used to transfer heat from one body to another, typically from a heat source (e.g., an vehicle engine, boiler, computer chip, or refrigerator), to a heat sink, to effect cooling of the heat source, heating of the heat sink, or to remove unwanted heat generated by the heat source. Heat transfer media provide thermal pathways between a heat source and a heat sink that dissipates the thermal energy. Thermal transfer media may also be integrated into flow systems, such as to improve heat flow or transfer thermal energy to a fluid flow system such as in a radiant heating system.

Several criteria have been used for selecting heat transfer media for specific applications. Exemplary criteria include the influence of temperature on heat transfer capacity and viscosity, and the energy required to maintain an integral flow system through a heat transfer system. Specific parameters describing the comparative performance of a heat transfer medium are density, thermal conductivity, specific heat, and electrical conductivity. The maximization of the heat transfer capability of any heat transfer system is important to the overall energy efficiency, material resource minimization, and system costs. There are numerous improvements in heat transfer systems that are further enhanced by increased thermal capacity. One example is the utilization of polymers suitable for standard plastic production processes such as injection molding, film forming and die-casting. Plastic production techniques are more cost effective, have a reduced total manufactured cost and weight, require a reduced labor component, and typically have lower assembly costs.

Other factors that affect the feasibility and performance of heat transfer media include environmental impact, toxicity, flammability, physical state at normal operating temperature, and corrosive nature. A variety of materials can be used as heat transfer media in systems where heat transfer efficiency is to be maximized and fluid flow transport energy minimized. Such media can benefit from cost effective methods to enhance thermal conductivity.

Electrical conductivity compositions are utilized in a wide range of applications including, though not limited to: conductive inks, circuit boards, paints, electromagnetic and radio frequency interference protective coatings, and antennas. Electrical conductivity compositions include a wide range of solids and liquids. For example, conductive polymers doped with metallic fillings. Electrically conductive media provide electron pathways between an electrical source and sink, respectively cathode and anode, to transfer electrical energy.

Several criteria for selecting electrical conductivity media include resistance and capacitance. Other factors that affect the feasibility and performance of conductive media include environmental impact, toxicity, flammability, physical state at normal operating temperature, and corrosive nature.

A variety of materials can be used as electrically conductive media in systems where electrical (electron) flow is to be maximized and resistance is minimized. Such media can benefit from cost effective methods to enhance electrical conductivity. The electrically conductive media may include a filler material that is electrically conductive to enhance the conductivity of the carrier medium.

The present invention provides a new and improved conductivity enhancement composition for comprised of nanoscale additives and their method of use.

### SUMMARY OF THE INVENTION

The term “nanoscale”, as used herein, are particles having a mean average diameter of less than 1 micron meter and more particularly having a mean average diameter of less than 100 nanometers.

The term “nanocomposite”, as used herein, are carrier media comprised of nanoscale particles.

The term “pyrophoric”, as used herein, refers to materials that have an inherent tendency to spontaneously ignite in air. The word is derived from Greek for “fire-bearing”. Many pyrophoric materials also react vigorously with water or high humidity, often igniting upon contact.

The term “passivation”, as used herein, refers to means as known in the art to eliminate or reduce a particles tendency to be pyrophoric, or chemically reactive.

The term “directionality”, as used herein, refers to the axial flow of electrons or thermal energy in the axial direction and therefore primarily within a specific conductive path.

The term “functionalized”, as used hererin, refers to means as known in the art including whereby compounds are emulsified to control of hydrophobic, hydrophilic or molecular polarity, or chemically bonded (including hydrogen bonding), and adsorbed.

The term “heat transfer fluid” is used interchangeably with “carrier medium” or “carrier media,” and is used herein as, gaseous or liquid fluids, solids, semi-solids, liquids, or phase change heat transfer materials which don't flow at the operating temperature of a heat transfer system, and includes materials which may be solid at room temperature, but that undergo a phase transition at the operating temperature of the system.

As used herein, the term heat transfer is used to imply the transfer of heat from a heat source to a heat sink, and applies to both heating and cooling (e.g., refrigeration) systems. The heat transfer means includes radiation, convection, conduction, wave propagation, and quantum means such as phonons.

The term “microetching” process combines the advantage of a controlled and locally enhanced (i.e. grain boundary) etch attack with those benefits of peroxide etching solutions (i.e. high metal load, constant etch rate, absence of byproducts). At very low etch rates the new process simultaneously creates an optimal “macro- and micro-structure” on the metal surface with dendritic features, therefore providing the increased surface area and reduced interfacial tension.

The term “quantum dots”, as herein referred, have zero-dimensional confinement and represent the ultimate in reduced dimensionality, i.e. zero dimensionality. The energy of an electron confined in a small volume by a potential barrier as in a quantum dot, hereinafter referred to as “QD” is strongly quantized, i.e., the energy spectrum is discrete. For QDs, the conduction band offset and/or strain between the QD and the surrounding material act as the confining potential. The quantization of energy, or alternatively, the reduction of the dimensionality is directly reflected in the dependence of the density of states on energy.

The term “graphite intercalation”, as used herein, is when graphite is in hexagonal lattices of carbon atoms that lie in a row like a network.

The term “alignment”, as used herein, is the process of aligning the flow of energy, and/or electrons in a particularly desired path through means known in the art including, though not limited to, electromagnetic forces, functionalizing carbon, ultrasonic forces, and applying shearing forces. Shearing forces known in the art include elongation, extrusion, pultrusion, and injection.

As used herein, the term “flow path” is used to imply the flow of electrons (i.e., electron transfer) from a cathode to anode.

The term “phase change material” as used herein, is a material that undergoes a phase change, typically between the liquid and solid phases. Phase change materials are frequently used in energy storage applications because larger amounts of energy can be stored as latent heat, i.e., the energy released by solidification or required for liquefaction, than as sensible heat, i.e., the energy needed to increase the temperature of a single phase material.

The inventive nanocomposite has enhanced conductivity whereby the composite has reduced conductivity path directionality dependence by being comprised of a combination of non-directional particles and directional particles. In accordance with the present invention, the non-directional particles comprise a powder selected from the group consisting of metals, metal oxides, alloys, and combinations thereof. In accordance with another aspect of the present invention the directional particles comprise a carbon powder. Said powders have an average particle size of from about 1 nanometer to about 100 microns.

In accordance with one aspect of the present invention, the powder selected from the group consisting of metal, alloys, and combinations thereof is passivated with a passivation layer by means known in the art to reduce the susceptibility to pyrophoric reactions.

In accordance with yet another aspect of the present invention, the carbon powder is further coated with a metal coating deposited on the surface of said carbon powders to increase the conductivity of said nanocomposite.

Another aspect of the present invention is the further mixing into said nanocomposite at least one conductive filler selected from the group consisting of conductive polymers, metallic coated glass beads, and metallic coated glass fibers.

In accordance with another aspect of the present invention, the powders functionalized to improve dispersion, to improve conductivity, or to reduce interfacial tension.

Another aspect of the present invention is the further functionalizing of the powders for at least one purpose selected from the group promoting dispersion, enhancing corrosion resistance, reducing friction, enhancing chemical stability, enhancing molecular polarity, modifying hydrophobic or hydrophilic characteristics, enhancing solubility, providing stability against thermal and ultraviolet degradation, enhancing lubricity, improving mold release, varying color, incorporating nucleating agents, enhancing plasticity, or enhancing means to make emulsions.

Another aspect of the present invention is the further mixing into said nanocomposite at least one surfactant to reduce the interfacial tension of the powders and carrier media.

Yet another aspect of the present invention is the further mixing in said nanocomposite quantum dots to further reduce the mean path length between said powders as a means to increase electron flow.

In accordance with another aspect of the present invention, the powders selected from group consisting of metals, metal oxides, alloys, and combinations thereof; and metal coating according is further subjected to microetching process as a means to increase the effective surface area through modifying the surface topography with nanoscale dendritic features.

In accordance with the present invention the powders selected from group consisting of metals, and metal oxides are selected from the group of at least one metal from Au, Ag, Pd, Pt, Cu, Ni, Fe, Co, Be, Mo, Si, Tn, Sn, Al, and In. Another aspect of the invention is the carbon powders are selected from the group of graphite, carbon nanotubes, diamond, fullerene carbons of the general formula (C₂)ₙ, where n is an integer of at least 30, or blends thereof.

Another inventive nanocomposite wherein enhanced conductivity is achieved is comprised of a metal powder, carbon powder, and coating on either of the metal or carbon powder. The said metal powder is selected from the group consisting of metals, metal oxides, metal salts, alloys, and combinations thereof. The said carbon powder and metal powder have an average particle size of from about 1 nanometer to about 100 microns. The said coating includes at least one chemical agent selected from the group consisting of organic corrosion inhibitors, inorganic corrosion inhibitors, ethylene oxide/polypropylene oxide block copolymers, surfactants, lignin, lignin derivatives, alkali metal salts, alkali earth metal salts, ammonium salts, alkyl ether phosphates, and combinations thereof.

Yet another inventive nanocomposite wherein enhanced conductivity is achieved is comprised of a metal powder, carbon powder, whereby the powders are manufactured into nanoscale powders by the sequential process steps of 1) carbon is derived from graphite flakes subjected to graphite intercalation, 2) metals, metal oxides, alloys, and combinations thereof are derived from solubilized metal compounds, 3) graphite intercalation compound is formed by said carbon and metal compounds; and 4) said graphite intercalation compound is vaporized.

In accordance with the present invention, the metal compounds are preferably selected from the group of copper, nickel, gold, and silver; and compounded preferably from at least one from the group of ammonia, and sulfuric acid. Another aspect of the invention is the more preferable selection of cupric ammonium as the metal compound.

Yet another aspect of the present invention is the further complexing with at least one chemical agent selected from the group consisting of organic corrosion inhibitors, inorganic corrosion inhibitors, ethylene oxide/polypropylene oxide block copolymers, surfactants, lignin, lignin derivatives, ammonium salts, alkyl ether phosphates, and combinations thereof. Preferred chemical agents for complexation are selected from the group consisting of azoles, benzotriazole, tolytriazole, halogen resistant azoles, and substituted derivatives thereof. Another aspect of the invention is the more preferable selection of the complexing chemical agent with an organic compounds comprised of only carbon, nitrogen, and hydrogen. In accordance to the present invention the particularly preferred chemical agent is benzotriazole.

In accordance with the present invention, any of the aforementioned nanocomposites are blended into a polymer matrix with said nanocomposite and manufactured by means known in the art into a heat exchanger.

In accordance with the present invention, any of the aforementioned nanocomposites are blended into a carrier media with said nanocomposite as an additive and manufactured by means known in the art into a heat transfer fluid.

In accordance with the present invention, any of the aforementioned nanocomposites are blended into a carrier media with said nanocomposite as a heat exchanger coating and manufactured by means known in the art into a heat exchanger.

In accordance with the present invention, any of the aforementioned nanocomposites are blended into a carrier media with said nanocomposite as an additive and manufactured by means known in the art into an electrically conductive media.

Without being bound by theory, it is believed that nanocomposites of this invention have enhanced conductivity by incorporating particles not having a preferred directional electron path (i.e., established by said non-carbon powders) in combination with particles having a directional electron path (i.e., typical of carbon powders).

Without being bound by theory, it is believed that in nanocomposites of this invention conductivity is enhanced by reducing the mean flow path with particles regardless of the inherent conductivity properties of said particles.

One advantage of the present invention is that the thermal and electrical conductivity, thermal capacity, electrical capacitance and transmission efficiency of host carrier medium are increased.

Yet another advantage of the present invention is that the coated, functionalized, or complexed nanocomposite is readily dispersed in the carrier media.

A further advantage of the present invention derives from stabilization and passivation of the coated, functionalized, or complexed nanocomposite, therefore enabling direct immersion into corrosive environments.

A yet further advantage of the invention is that the coated, functionalized, or complexed nanocomposite may maintain a mobile colloidal dispersion within the phase change material, enabling said nanocomposite to be utilized without the use of dispersion enhancement devices in a host heat transfer system.

A yet further advantage of the present invention is stronger adhesion strength within a nanocomposite having components of varying coefficient of thermal expansion.

A still further advantage of the present invention is reduced interfacial stress between the material components to enable higher loadings, and increased thermal and electrical conductivity.

Other advantages of the present invention derive from the enhanced thermal capacity of the heat transfer composition, which results in energy consumption reductions by reducing the incoming fluid temperature (in a cooling system) needed to achieve a targeted fluid leaving temperature. Reductions in fluid velocities may also be achieved, thereby reducing friction losses and pressure losses within a circulation pump.

A further advantage of the present invention is that by enabling the stabilizing of pure metals or their alloys to be used in a heat transfer system, heat transfer compositions with higher thermal transfer properties may be achieved as compared with compositions using oxidized forms of the metals or alloys.

Yet another advantage of the present invention is that the heat transfer coated compound is compatible with a wide range of heat transfer media, including, but not limited to media for applications ranging from engine cooling, heating, air conditioning, refrigeration, thermal storage, and in heat pipes, fuel cells, battery systems, hot water and steam systems, and microprocessor cooling systems.

A further advantage of the present invention is that by enabling stabilizing pure metals or their alloys to be used in an electrically conductive system, enhanced conductivity compositions with higher electron transfer properties may be achieved as compared with compositions using oxidized forms of the metals or alloys.

Yet another advantage of the present invention is that the nanocomposite is compatible with a wide range of carrier media, including, but not limited to media for applications ranging from circuit boards, conductive inks, electromagnetic and radio frequency protective coatings, fuel cells, battery systems, and paints.

Additional features and advantages of the present invention are described in and will be apparent from the detailed description of the presently preferred embodiments. It should be understood that various changes and modifications to the presently preferred embodiments described herein will be apparent to those skilled in the art. Such changes and modifications can be made without departing from the spirit and scope of the present invention and without diminishing its attendant advantages. It is therefore intended that such changes and modifications be covered by the appended claims.

### DETAILED DESCRIPTION OF THE PREFERRED EMBODIMENTS

The inventive nanocomposite having enhanced conductivity is now set forth as a composite comprised of a synergistic blend of nanoscale powders as a means of reducing the path dependence of carbon derived nanoscale particles. Carbon derived particles recognized as having superior conductivity include carbon nanotubes of both the single- and multi-wall variety. Unfortunately carbon nanotubes, as are their carbon counterparts including graphite, have conductivity primarily in the axial direction. The directionality of carbon nanoscale particles requires alignment in order to maximize the conductivity enhancement associated with said carbon particles though only in the axial direction.

Several means are detailed in order to incorporate the inventive synergistic blend of non-directional nanoscale particles. Non-directional particles are generally characterized as metal particles, or non-metal particles under specific conditions known in the art. Metal nanoscale particles are the preferred non-directional nanoscale particles due to their excellent inherent conductivity properties. Metal oxides are inherently inferior to the aforementioned metal particles, however have the distinct advantage of being non-pyrophoric. Another current advantage of metal oxides is the present state of art in manufacturing smaller nanoscale particles in direct comparison to metal particles. Given the exponential gain in conductivity as an inverse function of particle size, the smaller oxides often outperform their metal particle counterparts (i.e., metals are superior on a macroscale) in terms of both thermal and electrical conductivity. Pure metals or metal oxides are also preferred, though alloys or combinations thereof are still anticipated in the invention. Without being bound by theory, alloys specifically have reduced ability to transfer energy through phonons.

Said metal powders (and their derivatives, hereinafter referred to simply as metal powders) and carbon powders have an average particle size of from about 1 nanometer to about 100 microns. However, the most significant conductivity enhancement takes place within the true nanoscale region. In general, the smaller the particle size for said metal powders the better the conductivity enhancement. Exemplary of this fact is that 100 nanometer copper particles have ten times less thermal conductivity then 50 nanometer copper particles for equivalent weight additions. Therefore, metal powders having a mean average diameter of less than 100 nanometers are preferred. More particularly preferred metal powders are between 1 to 10 nanometers.

The aforementioned metal particles are preferably selected from the group of at least one metal from Au, Ag, Pd, Pt, Cu, Ni, Fe, Co, Be, Mo, Si, Tn, Sn, Al, and In. The more preferred metals include copper, nickel, silver, and gold. The particularly preferred metal includes copper and nickel, with the particularly preferred metal being copper due to its superior conductivity at the macroscale relative to its cost.

The aforementioned metal particles, especially of such nanoscale proportions are subject to cold fusion, high chemical reactivity, and oxidation. The more preferred metal particles are passivated with a passivation layer by means known in the art, also as a means to reduce the susceptibility to pyrophoric reactions. One such preferred means includes nitrogen passivation of copper nanoparticles.

Said carbon powders on an equivalent alignment basis demonstrate superior conductivity enhancements with mean particle diameters exactly as their metal powder counterparts. However, the longer the carbon powder length the superior conductivity performance gains. Therefore, carbon powders having a mean average diameter of less than 100 nanometers are preferred. More particularly preferred carbon powders are between 1 to 10 nanometers. More specifically preferred are carbon powders recognized in the art as single wall nanotubes. Single wall nanotubes having small diameters on the order of less than 10 nanometers are most preferred as the carbon powder. Herein lies the paradox that the best conductivity in an axial direction is obtained by nanotubes having very small diameters, thus the bulk of the carrier media is not in close proximity to the end of the nanotube. Thus the inventive combination of metal nanoscale particles in synergy with carbon nanotubes as a means to reduce the dependence on alignment of said nanotubes, further as a means to reduce the mean flow path between said nanotubes enhancing the probability of achieving quantum effects such as electron tunneling, phonon activation energy, and the like.

The aforementioned carbon powders are selected from the group of graphite, carbon nanotubes, diamond, fullerene carbons of the general formula (C₂)ₙ, where n is an integer of at least 30, or blends thereof. The more preferred carbon powders are nanotubes. And the specifically preferred carbon powders are single wall carbon nanotubes.

The conductivity of carbon particles can be further enhanced with a metal coating deposited on the surface of said carbon powders as a means to increase its conductivity. The preferred coating is also in the nanoscale proportions, so as to take advantage of the metals non-directionality in direct contact with the carbons axial direction.

Due to the higher cost relative to non-nanoscale particles, the invention anticipates the use of additional conductive fillers selected from the group consisting of conductive polymers, metallic coated glass beads, and metallic coated glass fibers. Such additives often have the additional benefit of providing structural and strength benefits in addition to the enhanced conductivity.

Nanoscale particles have an increasing impact from interfacial tension. The earlier invention of complexing nanoscale metal or carbon particles as a means of enhancing conductivity even when such complexing agent is not intrinsically conductive proves the importance. As such, both metal and carbon particles perform with superior conductivity when said particles are functionalized. The more preferred functionalizing agents improve dispersion, or reduce interfacial tension as a means to improve conductivity.

Manufacturability and long-term performance is also dependent on many factors as recognized in the art. Such methods as known in the art include functionalizing of the powders for at least one purpose selected from the group promoting dispersion, enhancing corrosion resistance, reducing friction, enhancing chemical stability, enhancing molecular polarity, modifying hydrophobic or hydrophilic characteristics, enhancing solubility, providing stability against thermal and ultraviolet degradation, enhancing lubricity, improving mold release, varying color, incorporating nucleating agents, enhancing plasticity, or enhancing means to make emulsions. The selection of the functionalizing agent is application specific. One such application is lubricants whereby the preferred functionalizing agent will also improve lubricity. The manufacturing of the inventive nanocomposite into a plastic heat exchanger will significantly benefit from the addition of mold release additives.

Another derivation of the inventive nanocomposite is comprised of the further synergistic blend of coated nanoscale particles consisting of both metal and carbon powders. The said coating includes at least one chemical agent selected from the group consisting of organic corrosion inhibitors, inorganic corrosion inhibitors, ethylene oxide/polypropylene oxide block copolymers, surfactants, lignin, lignin derivatives, alkali metal salts, alkali earth metal salts, ammonium salts, alkyl ether phosphates, and combinations thereof.

Another such means as reducing the interfacial tension is the further mixing at least one surfactant into the carrier media. The surfactants include the group of anionic surfactants, ionic surfactants and nonionic surfactants.

As implied earlier, the nanoscale particles enter the boundary between classical and quantum physics. As such, any means to reduce the energy barrier for electron tunneling and phonon activation will significantly enhance conductivity. One such means is the further mixing of quantum dots. The addition of quantum dots, though not bound to theory, reduces the mean path length between said powders as a means to increase electron flow through its ability to store energy.

The implicit parameter affecting conductivity enhancement performance is surface area. It is anticipated in this invention that the practice as recognized in the art of microetching serves as one means to increase surface area. The increase in surface area in the nanoscale realm requires microetching processes that result in modifying of the surface topography with nanoscale dendritic features. One such means is the usage of hydrophilic organic groups in order to form complexes with the copper of the substrate. The complexes have different chemical stability and solubility in the subsequent process solutions. If a complex is very stable (thermodynamically favored) and insoluble in subsequent process solutions, it can cause etch retardation. In many cases, these stable complexes are formed by materials having a relatively high molecular weight.

Numerous applications not centered around conductivity require purity of nanoscale particles, whether the particles are metal or carbon powders. The synergy between the metal and carbon nanoparticles of said nanocomposites actually encourages cross contamination of carbon and metal. Couple this design and composition desirability, the utilization of numerous metals as a catalyst for the production of structured carbon particles. Most specifically, it is recognized in the art that metal nanoscale particles (i.e., copper and nickel) are preferred catalyst for the growth of carbon nanotubes. Furthermore, the smaller the particle size the increased likelihood of obtaining single wall carbon nanotubes.

However, the means to produce extremely fine (i.e., less than 10 nanometer mean average diameter) metal particles is itself a difficult and expensive proposition. Surprisingly, the use of graphite as a container limits the cold fusion and agglomeration of copper nanoparticles during its synthesis. Therefore, an extremely effective means of simultaneously producing metal nanoparticles and carbon nanotubes is detailed in the following exemplary sequential steps:

a) carbon is derived from graphite flakes subjected to graphite intercalation by methods known in the art that are applied to the present invention;

b) metals, metal oxides, alloys, and combinations thereof are derived from solubilized metal compounds, wherein the metal is preferably selected from the group of copper, nickel, gold, or silver;

c) graphite intercalation compound is formed by said carbon and metal compounds, wherein the preferred metal is compounded with at least one from the group of ammonia, and sulfuric acid, and particularly preferred with ammonia thus forming cupric ammonium; and

d) said graphite intercalation compound is vaporized by methods known in the art that are applied to the present invention.

Example 1 below details the procedure for manufacture of said nanocomposite.

Pre-complexing the above metal compound, say for example cupric ammonium, with at least one chemical agent selected from the group consisting of organic corrosion inhibitors, inorganic corrosion inhibitors, ethylene oxide/polypropylene oxide block copolymers, surfactants, lignin, lignin derivatives, ammonium salts, alkyl ether phosphates, and combinations thereof has the further benefit of enhanced separation between individual copper ions. In the specific instance of solubilizing the cupric ammonium with benzotriazole avoids the precipitation that occurs with copper sulfate. The benzotrizaole is also beneficially comprised only of carbon, nitrogen, and hydrogen (C sub 6 H sub 5 and N sub 3). The vaporization steps also breakdowns benzotrizaole into its constituents, whereby the hydrogen reduces the cupric ammonia, the nitrogen is then available for surface passivation of the resulting copper nanoscale particle, and the carbon is available for formation of carbon nanotubes.

The inventive nanocomposite, regardless of the manufacturing process of the individual constituents, is blended into a polymer matrix with said nanocomposite and manufactured by means known in the art into a heat exchanger. The heat exchanger performs with significantly improved heat transfer characteristics.

The inventive nanocomposite, regardless of the manufacturing process of the individual constituents, is blended with a carrier media with said nanocomposite as an additive and manufactured by means known in the art into a heat transfer fluid. The heat fluid has significantly improved heat transfer characteristics.

The inventive nanocomposite, regardless of the manufacturing process of the individual constituents, is blended with a carrier media with said nanocomposite as an additive for a heat exchanger coating and manufactured by means known in the art into a heat exchanger with enhanced surface area. The heat exchanger performs with significantly improved heat transfer characteristics.

The inventive nanocomposite, regardless of the manufacturing process of the individual constituents, is blended into a carrier media with said nanocomposite and manufactured by means known in the art into a conductive medium. The conductive medium performs with significantly improved electrical conductivity properties.

The following details in more specificity the numerous functionalizing, complexing, carrier media, and chemical agents available and practiced in this invention. The suitability of each is recognized in the art and could be applied to the present invention.

Exemplary coating compound include azoles and their substituted derivatives, particularly aromatic azoles (including diazoles, triazoles, and tetrazoles), such as benzotriazole, tolyltriazole, 2,5-(aminopentyl) benzimidazole, alkoxybenzotriazole, imidazoles, such as oleyl imidazoline, thiazoles, such as mercaptobenzothiazole, 1-phenyl-5-mercaptotetrazole, thiodiazoles, halogen-resistant azoles, and combinations thereof. Examples of halogen-resistant azoles include 5,6-dimethyl-benzotriazole; 5,6-diphenylbenzotriazole; 5-benzoyl-benzotriazole; 5-benzyl-benzotriazole and 5-phenyl-benzotriazole. Alkyl-substituted aromatic triazoles, such as tolyltriazole are particularly preferred. Azoles are particularly useful with copper-containing powders, such as pure copper or copper alloys, e.g. brass, but also have application with other metal-based powders, such as those formed from aluminum, steel, silver, and their alloys.

Other suitable coating compounds include inorganic corrosion inhibitors, including, but not limited to water-soluble amine salts, phosphates, and salts of transition elements, such as chromate salts. These coating compounds may also be used in combination with other corrosion inhibitors, such as azoles, to provide a “self heal” function. Lignin-based coating compound may also be used, in particular with carbon-based powders.

Ethylene oxide/propylene oxide (EO/PO) block copolymers may also be used as coating compound. Surfactants, such as anionic and nonionic surfactants, may also be used as coating compound, particularly for carbon. Exemplary anionic surfactants include calcium salts of alkylbenzenesulfonates. Exemplary nonionic surfactants include polyoxyalkylene alkyl ethers and polyoxyethylene/polyoxypropylene polymers.

Tolyltriazole is a particularly effective coating compound for copper. One preferred nano-particle size powder includes copper powder to which tolyltriazole is applied at from about 1-5% by weight. For aluminum and its alloys, cerium-based coating compound may be used. For example, an aqueous cerium non-halide solution is first applied to the powder, followed by contacting the treated surface with an aqueous cerium halide solution. For copper and silver particles, in particular, thiodiazoles substituted on the ring by a mercapto group and/or an amino group and triazoles substituted by a mercapto group and/or an amino group are effective. These compounds form a film on the particles. Oleyl imidazoline is particularly effective for steel. Ferrous and copper alloys can benefit from coating compound corrosion inhibitors sold under the trademark TRIM, available from Master Chemical Corporation of Toledo, Ohio that include triethanolamine and monoethanolamine.

Combinations of two or more azoles may be particularly effective, such as a combination of alkoxybenzotriazole, mercaptobenzothiazole, tolyltriazole, benzotriazole, a substituted benzotriazole, and/or 1-phenyl-5-mercaptotetrazole. Another combination, which is particularly effective for metallic surfaces, is a mixture of a pentane-soluble imidazoline, a pentane-soluble amide, a pyridine-based compound, a pentane-soluble dispersant, and a solvent.

Other corrosion inhibitors/passivating agents may be used which result in passivation of the powder and/or achieve a desirable effect on dispersion and redispersion.

For carbon-containing powders, such as graphite, carbon nanotubes, or blends of these carbon derivatives, suitable coating compounds, include lignin and its derivatives. In the paper making industry, lignin may be recovered as a by-product of the cellulose product. Depending on conditions under which the lignin is precipitated, the precipitated lignin may be either in the form of free acid lignin or a lignin salt. A monovalent salt of lignin, such as an alkali metal salt or an ammonium salt, is soluble in water, whereas free acid lignin and polyvalent metal salts of lignin are insoluble in water. In the case of carbon-based powders, the chemical additive tends to act as a dispersant, rather than as a corrosion inhibitor/passivation agent.

Other coating compound particularly useful with carbon-based powders include alkali metal salts, alkali earth metal salts, ammonium salts, alkyl ether phosphates, solvents, butyl ether and other surfactants, and the like.

The lignin-based compounds may be used alone or in combination with other coating compounds. Lignin sulfonic acid, alkali metal salts of lignin sulfonic acid, alkaline earth metal salts of lignin sulfonic acid, and ammonium salts of lignin sulfonic acid act as an anionic, surfactant-like component.

Such lignin-based compounds can be present in the coating compound either individually or in the form of mixtures of two or more compounds. For example, lignin sulfonic acid and/or alkali metal, alkaline earth metal and/or ammonium salts and one or more alkyl ether phosphates are effective coating compounds for carbon-based powders. Storage stable, low viscosity dispersants can also be made by replacing 10-25% of the submicron lignin with an acrylic resin, a rosin resin, a styrene-maleic anhydride copolymer resin, or a combination thereof. These are effective coating compounds for carbon-based powders, in particular. For example, the coating compound may include a lignin sulfonic acid and/or an alkali metal, alkaline earth metal, or ammonium salt. Other suitable combinations include a mixture of aminoethylated lignin and a sulfonated lignin.

While not fully understood, it is thought that lignin-based compounds reduce the interfacial tension between the carbon particles and the aqueous phase in order to wet the surface of the carbon particles.

As is apparent, the choice of a preferred coating compound may depend not only on the material from which the powder is formed, but also on the chemical environment, for example, whether the carrier medium is generally hydrophobic or hydrophilic, the desirability of reducing friction losses in the operating system in which the nanocomposite is to be used, and the desirability of maintaining a long term dispersion within the enhanced conductivity composition.

For example, in compositions where a high chemical resistance is desired, a neutral or alkaline azole, such as 2,5-(aminopentyl) benzimidazole may be used as the coating compound. Hydrophobic additives tend to maintain superior dispersions when the carrier medium is significantly hydrophobic. Hydrophilic additives tend to maintain superior dispersions when the carrier medium composition is significantly hydrophilic.

While the exact process by which dispersion is improved and maintained by the coating compound is not known, it is thought that organic corrosion inhibitors, such as heterocyclics react with the metal powder surface to form an organometallic complex. This takes the form of at least one, preferably several monolayers on the surface of the particle. The corrosion inhibitive action of such coating compounds upon the metal powder is manifest even at molecular layer dimensions, while unexpectedly achieving enhanced dispersion of the coated compound in the carrier medium. While aromatic azoles are believed to bond directly to the metal surface to produce an inhibiting complex, other surface interactions which result in a modification of the surface resulting in improved dispersion and/or passivation are also contemplated.

One or more of such coated powders may be used in combination with a carrier medium.

In addition to a coating compound, a suitable solvent may also be used. Common solvents may be used for this purpose.

In addition to a coating compound, suitable antioxidants, heat stabilizers and UV stabilizer, lubricants and mold release agents, colorants, such as dyes and pigments, fibrous and pulverulent fillers and reinforcing agents, nucleating agents and plasticizers may also be used. Common stabilizers and antioxidants, heat stabilizers and UV stabilizer, lubricants and mold release agents, colorants, such as dyes and pigments, fibrous and pulverulent fillers and reinforcing agents, nucleating agents and plasticizers may be used for this purpose. Such additives are used in the conventional effective amounts. The antioxidants and heat stabilizers which can be added to the thermoplastic materials according to the invention include those which are generally added to polymers, such as halides of metals of group I of the periodic table, e.g. sodium halides, potassium halides and lithium halides, in conjunction with copper(I) halides, e.g. the chloride, bromide or iodide. Other suitable stabilizers are sterically hindered phenols, hydroquinones, variously substituted members of this group and combinations of these, in concentrations of up to 1% by weight, based on the weight of the mixture. Suitable UV stabilizers are likewise those that are generally added to polymers, these stabilizers being employed in amounts of up to 2% by weight, base on the mixture. Examples of UV stabilizers are variously substituted resorcinols, salicylates, benzotriazoles, benzophenones, etc. Suitable lubricants and mold release agents, which may be added, for example, in amounts of up to 1% by weight, based on thermoplastic material, are stearic acids, stearyl alcohol, stearates and stearamides. Organic dyes, such as nigrosine, and pigments, e.g. titanium dioxide, cadmium sulfide, cadmium sulfide selenide, phthalocyanines, ultramarine blue or carbon black, may also be added. Moreover, the novel molding materials may contain fibrous and pulverulent fillers and reinforcing agents, such as carbon fibers, glass fibers, amorphous silica, asbestos, calcium silicate, calcium metasilicate, aluminum silicate, magnesium carbonate, kaolin, chalk, quartz powder, mica or feldspar, in amounts of up to 50% by weight, based on the molding material. Nucleating agents, such as talc, calcium fluoride, sodium phenylphosphinate, alumina or finely divided polytetrafluoroethylene, may also be used, in amounts of, for example, up to 5% by weight, based on material. Plasticizers, such as dioctyl phthalate, dibenzyl phthalate, butylbenzyl phthalate, hydrocarbon oils, N-n-butylbenzenesulfonamide and o- and p-tolueneethylsulfonamide are advantageously added in amounts of up to about 20% by weight, based on the molding material. Colorants, such as dyes and pigments, can be added in amounts of up to about 5% by weight, based on the molding material.

The composition may further include a prestabilized filler to further enhance the effectiveness of the surface modification. For example a material that will inhibit oxidation of the particle, for example, a noble metal, such as gold or silver, with or without a fatty acid may be used as prestabilized filler in combination with powder particles treated with one of the coating compounds described above. One or more of such fillers may be used in combination with a carrier medium.

The treated powder formed by treating the powder with a coating compound as described above may include an optional further functionalization agent, such as a treatment with polytetrafluoroethylene (PTFE, sold under the trademark TEFLON by E. I. Du Pont de Nemours and Co., Wilmington, Del.). Such functionalization may be carried out by solvent polymerization of copolymers containing monomer units useful as coating additives. The tolytriazole, or other azole used as the coating compound, may be functionalized prior to mixing with the powder. Such PTFE-functionalized azoles are commercially available.

Such functionalization agents tend to reduce the coefficient of friction associated with the treated powder. Less polar fluids, such as alcohols and alkylglycols, which add hydrophobic characteristics that enhance the coated powders dispersion, within the medium, may also be used as functionalization agents. Functionalization agents may also be used to accelerate the re-dispersion time of the coated compound in the enhanced conductivity composition. Functionalization agents that provide surface modification or functional group substitution may also be used. Other benefits of certain functionalization agents include a reduction or elimination of mixing mechanisms and lower friction that enables reduced horsepower. The functionalized treated powder may enable the reduction of surfactants and dispersants to enhance further the thermal and electrical conductivity of carrier systems.

Other functionalization agents may be used to increase control of hydrophobic, hydrophilic, and molecular polarity qualities associated with treated metal powders.

The enhanced conductivity composition may further comprise additives, such as surfactants to reduce further the interfacial tension between the components. The interface between components typically contains voids and airspace that detracts from higher heat transfer coefficients and electrical resistance. For example, co-corrosion inhibitors selected from the group of aromatic acids and naphthenic acids, which acids have the free acid form or the alkaline, alkaline earth, ammonium and/or amine salt form may be used. Sodium benzoate, however, is generally not suitable.

The composition may further include additives, such as traditional dispersants to maintain superior dispersions within the carrier medium. For example, a low molecular weight dispersant may be applied as a coating to the powder and having a polar group with an affinity for the carrier media. Hydrophobic dispersants will maintain superior dispersions when the carrier media is significantly hydrophobic. Hydrophilic dispersants will maintain superior dispersions when the carrier media is significantly hydrophilic. The composition may further include materials that reduce the surface friction between the coated powder and any surfaces in the enhanced conductivity systems.

The stabilized nano-particle to micron-particle size powder provides increased operational energy efficiencies to the carrier medium through its enhanced thermal capacity, reduced electrical resistance, and enhanced electrical capacitance. The enhanced conductivity composition also reduces the need for dispersal mechanisms in phase change systems. The enhanced conductivity composition exhibits slow settling and soft settling characteristics and maintains a colloidal dispersion, as compared with conventional conductivity enhancement additives. This enables enhanced conductivity systems to operate with higher energy efficiencies through utilizing of said enhanced conductivity composition.

The carrier medium preferably has a high heat transfer capacity, high thermal loading capacity, low electrical resistance and long-term thermal and chemical stability throughout the range over which the composition is to be operated. Suitable carrier media include solids, gaseous and liquid fluids and phase change materials. These types of carrier media include, for example, fluids that are gaseous under atmospheric pressure but are liquid or semi-liquid under the ambient operating conditions of the conductivity system, and viscous fluids. Phase change materials are those that change from one phase, such as a solid, to a flowable material, such as a liquid or viscous fluid, at the operating temperature of the composition.

Additives may be employed in combination with a variety of carrier media. For example, additives may be included in water or other aqueous systems, such as, for example, aqueous brines (e.g., sodium or potassium chloride solution, sodium or potassium bromide solution, and the like), and mixtures of water with alcohols, glycols, ammonia, and the like. Additives may also be included in organic-based systems, suitable media for these applications including materials such as hydrocarbons, mineral oils, natural and synthetic oils, fats, waxes, ethers, esters, glycols, and various halogen derivatives of these materials, such as CFCs, hydrochlorofluorocarbons (HCFCs), and the like. These carrier media may be used alone or in combination. Mixed organic and aqueous carrier media may also be used, such as a mixture of water and ethylene glycol. One preferred mixed carrier media includes ethylene glycol and water in a volume ratio of from about 5:1 to about 1:5.

Exemplary non-phase change materials include interpolymers prepared by polymerizing one or more alpha-olefin monomers with one or more vinylidene aromatic monomers and/or one or more hindered aliphatic or cycloaliphatic vinylidene monomers, and optionally with other polymerizable ethylenically unsaturated monomer(s).

Exemplary non-phase change materials include conjugated polymers, crystalline polymers, amorphous polymers, epoxies, resins, acrylics, polycarbonates, polyphenylene ethers, polyimides, polyesters, acrylonitrile-butadiene-styrene (ABS); polymers such as polyethylene, polypropylene, polyamides, polyesters, polycarbonates, polyphenylene oxide, polyphenylene sulphide, polyetherimide, polyetheretherketone, polyether ketone, polyimides, polyarylates, styrene, poly(tetramethylene oxide), poly(ethylene oxide), poly(butadiene), poly(isoprene), poly(hydrogenated butadiene), poly(hydrogenated isoprene), liquid crystal polymers, polycarbonate, polyamide-imide, copolyimides precursors, reinforced polyimide composites and laminates made from said polyimides, polyphenylated polynuclear aromatic diamines, fluorocarbon polymers, polyetherester elastomers, neoprene, polyurea, polyanhydride chlorosulphonated polyethylene, and ethylene/propylene/diene (EPDM) elastomers, polyvinyl chloride, polyethylene terephthalate, polyvinylchloride, ABS, polystyrene, polymethylmethacrylate, polyurethane and high performance engineering plastics, polyacrylate, polymethacrylate, and polysiloxane, aromatic copolyimide, polyalpholefins, polythiophene, polyaniline, polypyrrole, polyacetylene, polyisocyanurates, their substituted derivatives and similar polymers. Such polymers may contain stabilizers, pigments, fillers and other additives known for use in polymer compositions. Using benzocyclobutene shows many promising benefits. In addition to many other advantages, such as its lower dielectric constant and good adhesion to copper, benzocyclobutene has the significant capability for producing a level surface over heavily patterned under-layers.

Further exemplary carrier medium include monomers that further include vinyl monomers such as styrene, vinyl pyridines, N-vinyl pyrrolidone, vinyl acetate, acrylonitrile, methyl vinyl ketone, methyl methacrylate, methyl acrylate, 2-hydroxyethyl methacrylate, 2-hydroxyethyl acrylate; polyols such as ethylene glycol, 1,6-hexane diol, and 1,4-cyclohexanedicarbinol; polyamines such as 1,6-hexadiamine and 4,4′-methylenebis (Nmethylaniline); polycarboxylic acids such as adipic acid and phthalic acids; epoxides such as ethylene oxide, propylene oxide, and cyclohexene oxide; and lactams such as epsiloncaprolactam.

Further exemplary carrier medium include polymers that further include poly(alkylene glycols) such as poly(ethylene glycol) (PEG), and poly(propylene glycol) (PPG); vinyl polymers such as poly(styrene), poly(vinyl acetate), poly(vinylpyrrolidone), poly(vinylpyridine), and poly(methyl methacrylate); organic liquid-soluble polysaccharides or functionalized polysaccharides such as cellulose acetate; and crosslinked swellable polysaccharides and functionalized polysaccharides.

Exemplary phase change medium include salt-hydrates, organic eutectics, clathrate-hydrates, paraffins, hydrocarbons, Fischer-Tropsch hard waxes, and inorganic eutectic mixtures. Examples of these phase change materials include inorganic and organic salts, preferably ammonium and alkali and alkali earth metal salts, such as sulfates, halides, nitrates, hydrides, acetates, acetamides, perborates, phosphates, hydroxides, and carbonates of magnesium, potassium, sodium, and calcium, both hydrated and unhydrated, alone or in combination with these or other media components. Examples of these include potassium sulfate, potassium chloride, sodium sulfate, sodium chloride, sodium metaborate, sodium acetate, disodium hydrogen phosphate dodecahydrate, sodium hydroxide, sodium carbonate decahydrate, hydrated disodium phosphate, ammonium chloride, magnesium chloride, calcium chloride, calcium bromide hexahydrate, perlite embedded with hydrogenated calcium chloride, lithium hydride, and lithium nitrate trihydrate. Other suitable phase change media include acetamide, methyl fumarate, myristic acid, Glauber's salt, paraffin wax, fatty acids, methyl-esters, methyl palmitate, methyl stearate, mixtures of short-chain acids, capric and lauric acid, commercial coconut fatty acids, propane and methane and the like.

In secondary loop systems, preferred carrier media include glycols, such as ethylene glycol, water, poly-α-olefins, silicate esters, chlorofluoro carbon liquids sold under the tradename FLUORINERT, such as FC-70, manufactured by the 3M Company. Polyaromatic compounds may also be used, such as biphenyl, diphenyl oxide, 1,1 diphenyl ethane, hydrogenated terphenylquatraphenyl compounds, and mixtures thereof, and dibenzyl toluene. Eutectic mixtures of two or more compounds may also be used, such as a eutectic mixture sold under the tradename DOWTHERM A by Dow Chemical Co., which includes 73% diphenyl oxide and 27% biphenyl. Other preferred carrier media for secondary loop systems include mineral oils and waxes, such as naphthenic and paraffinic oils and waxes, particularly those specified for high temperature applications, natural fats an oils, such as tallow and castor oils, synthetic oils, such as polyol esters, polyolefin oils, polyether oils, and the like.

For primary loop systems, suitable carrier media include water, aqueous solutions, salts, CFCs, HCFCs, perfluorinated hydrofluorocarbons (PFCs), highly fluorinated hydrofluorocarbons (HFCs), hydrofluorocarbon ethers (HFEs), and combinations thereof. Azeotropic mixtures of carrier media may be used. Propane and other natural gases are also useful in some applications.

Exemplary primary loop media include salt-hydrates, organic eutectics, clathrate-hydrates, paraffins, hydrocarbons, Fischer-Tropsch hard waxes, and inorganic eutectic mixtures. Examples of these primary loop media include inorganic and organic salts, preferably ammonium and alkali and alkali earth metal salts, such as sulfates, halides, nitrates, hydrides, acetates, acetamides, perborates, phosphates, hydroxides, and carbonates of magnesium, potassium, sodium, and calcium, both hydrated and unhydrated, alone or in combination with these or other media components. Examples of these include potassium sulfate, potassium chloride, sodium sulfate, sodium chloride, sodium metaborate, sodium acetate, disodium hydrogen phosphate dodecahydrate, sodium hydroxide, sodium carbonate decahydrate, hydrated disodium phosphate, ammonium chloride, magnesium chloride, calcium chloride, calcium bromide hexahydrate, perlite embedded with hydrogenated calcium chloride, lithium hydride, and lithium nitrate trihydrate. Other suitable primary loop media include acetamide, methyl fumarate, myristic acid, Glauber's salt, paraffin wax, fatty acids, methyl-esters, methyl palmitate, methyl stearate, mixtures of short-chain acids, capric and lauric acid, commercial coconut fatty acids, propane and methane and the like.

Propylene glycol, mineral oil, other oils, petroleum derivatives, ammonia, and the like may also be used.

The selection of a preferred carrier medium is in part dependent on the operating temperature range, heat transfer effectiveness, electrical conductivity effectiveness, cost, viscosity within the operating temperature range, and environmental impact if the material is likely to leave the system.

The coated powder is particularly useful in combination with carrier medium that tend to be in corrosive environments, such as high humidity environments.

Alternatively, the thermal and electrical conductivity enhancement composition may be combined as a blend, solution, or other mixture (azeotropic or otherwise) with one or more other materials. Such other materials may include additives and substances used to alter the physical properties of the carrier medium.

In yet another embodiment, the thermal and electrical conductivity enhancement composition is supplied in concentrated form, together with one or more of the components of a carrier medium, for later combination with the remaining components. For example, all of the components of a thermal and electrical conductivity enhancement composition, including the enhanced conductivity powder composition, but with the exception of monomers, are combined and supplied as a concentrate. When needed, the concentrate is mixed or otherwise combined with monomers, other bulk material, or added to an existing system in which the thermal and electrical conductivity enhancement composition and/or other components of the heat transfer medium have become depleted over time.

For example, the chemical additive may be first combined with a suitable solvent in which the chemical additive is soluble. Heat may be applied, if desired, to effect solubilization. The powder is then added to the mixture and allowed to contact the powder and interact to form the treated powder. Other additives, such as functionalizing agents and surfactants may also be added to the mixture. Excess chemical additive may be removed by filtering the treated powder then washing the treated filtered powder in a suitable solvent, which may be the same solvent used to dissolve the chemical additive, or a different solvent. The washed or unwashed treated powder is then dried, either by air-drying or in an oven at a sufficient temperature to remove the solvent without deleteriously affecting the properties of the additive. Alternatively, for example, where the solvent is useful in carrier medium, the drying step may be avoided. In another alternative embodiment, the treated powder is filtered to remove the solvent and/or excess chemical additive. The optimal amount of the additive used depends on the particular application, the composition of the additive, and the host carrier medium's ability to maintain the additive as a dispersion in the enhanced conductivity composition. The cost to benefit ratio in terms of increased energy efficiency may also be a factor in determining the preferred concentration. The additive may be present in the enhanced conductivity composition at a concentration of from about 1 to 99% by weight, more preferably from about 3-20% by weight, and most preferably, around 10% by weight.

The additives used in accordance with the present invention preferably maintain a colloidal dispersion, are not prone to gas phase change, and have a high heat transfer capacity and low electrical resistance with low viscosity over the entire intended operating range. Preferred additives are also nonflammable, environmentally friendly, non-toxic, and chemically stable. The additive exhibits compatibility with a wide range of carrier media and applications over a wide range of operating conditions. Additives formed according to the present invention exhibit effectiveness within both primary and secondary loop carrier media as dispersion and closed loop re-circulation is achieved in non-phase change and phase change processes. The carrier media additive may be used in a variety of applications, including engine cooling, air conditioning, refrigeration, thermal storage, heat pipes, fuel cells, batteries, circuit boards, inks, paints, and hot water and steam systems.

In yet another alternative embodiment, the coating compound is added to a mixture of the carrier medium and the powder. In this embodiment the coating compound still contacts the powder surface and modifies the surface properties, either by chemically modifying the surface, physical adsorption or some other form of interaction.

The optimal amount of the coated powder used depends on the particular application, the composition of the carrier medium, and the host carrier medium's ability to maintain the thermal and electrical conductivity enhancement composition as a dispersion in the enhanced conductivity composition. The cost to benefit ratio in terms of increased energy efficiency may also be a factor in determining the preferred concentration. The coated powder may be present in the inventive enhanced conductivity composition at a concentration of from about 1 to 99% by weight, more preferably from about 3-90% by weight, and most preferably, around 30% by weight. Preferably, the coating compound is present in stoichiometric excess. By this, it is meant that the coating compound is present in sufficient amount to provide at least a monolayer of coverage over the available surface of the particles.

In yet another embodiment, the precursor powder has an average particle sizes in the nanometer to micron size range being produced by a process step selected from the group of solubilized, dispersed, emulsified, grinded, spray atomized and vaporized, whereby the precursor powder (prior to being coated, complexed, or adsorbed by coating material) is produced with the coating compound in situ. In this embodiment the coating compound is prepared by one process selected from the group of complexing a coating compound with powder particles, adsorbing a coating compound on surfaces of the powder particles, and imparting a metal coating onto surfaces of powder particles and subsequently complexing the metal coating with another coating. The precursor powder has coating imparted onto its surface while in a reaction medium selected from the group of solvents, fluids, monomers, interpolymers, polymers, and phase change materials.

Without intending to limit the scope of the invention, the following example describes a method of forming and using the heat transfer compositions of the present invention.

### EXAMPLES

### Example 1

a) carbon is derived from graphite flakes subjected to graphite intercalation by methods known in the art that are applied to the present invention.

High quality particulate graphite flake are processed through an intercalation process and by using cupric ammonium in combination with solubilized tolytriazole.

b) The resulting copper ammonia tolytriazole graphite intercalation compound is vaporized by methods known in the art that are applied to the present invention.

c) The vaporized intercalation compound is then subjected to processes known in the art for producing nanotubes that are applied to the present invention.

The available hydrogen serves as a reducing agent to the copper compound in both this process step and the preceding step.

### Example 2

Copper nanoscale particles (2% on a total weight basis) having a mean average diameter of 10 nanometers are mixed into a heat transfer fluid solution of comprised of a 1:1 ratio of ethylene glycol and deionized water. Carbon single wall nanotubes (2% on a total weight basis) having a mean average diameter of 1 nanometer are further mixed into solution.

### Example 3

Copper nanoscale particles (2% on a total weight basis and having a mean average diameter of 10 nanometers) are passivated by means known in the art using nitrogen. The passivated copper particles are then mixed into a heat transfer fluid solution of comprised of a 1:1 ratio of ethylene glycol and deionized water. Carbon single wall nanotubes (2% on a total weight basis) having a mean average diameter of 1 nanometer are further mixed into solution.

### Example 4

Copper nanoscale particles (2% on a total weight basis and having a mean average diameter of 10 nanometers) are passivated by means known in the art using nitrogen. The passivated copper particles are then mixed into a heat transfer fluid solution of comprised of a 1:1 ratio of ethylene glycol and deionized water. Carbon single wall nanotubes (2% on a total weight basis and having a mean average diameter of 1 nanometer) are coated with copper by means known in the art. The resulting coated nanotubes are further mixed into solution.

### Example 5

Copper nanoscale particles (2% on a total weight basis) having a mean average diameter of 10 nanometers are blended with carbon single wall nanotubes (2% on a total weight basis) having a mean average diameter of 1 nanometer. The resulting blend of copper and carbon nanoscale particles are further mixed into a polyimide polymer whereby the polymer is at a temperature above its melt temperature by means known in the art. The use of shear forces result in both film forming and nanoparticle alignment.

### Example 6

Copper nanoscale particles (2% on a total weight basis and having a mean average diameter of 10 nanometers) are passivated by means known in the art using nitrogen. The passivated copper particles are then mixed into a heat transfer fluid solution of comprised of a 1:1 ratio of ethylene glycol and deionized water, and solubilized tolytriazole (1% on a total weight basis). Carbon single wall nanotubes (2% on a total weight basis) having a mean average diameter of 1 nanometer are further mixed into solution.

### Example 7

Copper nanoscale particles (2% on a total weight basis and having a mean average diameter of 10 nanometers) are passivated by means known in the art using nitrogen. The passivated copper particles are then mixed into a heat transfer fluid solution of comprised of a 1:1 ratio of ethylene glycol and deionized water, and solubilized and functionalized (with polytetrafluoroethylene) tolytriazole (1% on a total weight basis). Carbon single wall nanotubes (2% on a total weight basis) having a mean average diameter of 1 nanometer are further mixed into solution.

### Example 8

Copper nanoscale particles (2% on a total weight basis) having a mean average diameter of 10 nanometers are microetched with Resistassist (manufactured by Atotech) in accordance to the standard usage means except for a 90% reduction in microetching time. The microetched copper particles and carrier solution is doped with tolytriazole. The resulting modified copper particles are subsequently dried and then mixed into a heat transfer fluid solution of comprised of a 1:1 ratio of ethylene glycol and deionized water. Carbon single wall nanotubes (2% on a total weight basis) having a mean average diameter of 1 nanometer are further mixed into solution.

The invention has been described with reference to the preferred embodiment. Obviously, modifications and alterations will occur to others upon reading and understanding the preceding detailed description. It is intended that the invention be construed as including all such modifications and alterations insofar as they come within the scope of the appended claims or the equivalents thereof.

What is claimed is:

1. An enhanced conductivity nanocomposite, wherein the composite has reduced conductivity path directionality dependence, comprising of:
a powder selected from the group consisting of metals, metal oxides, alloys, and combinations thereof, the powder having an average particle size of from about 1 nanometer to about 100 microns, and
a carbon powder wherein the powder having an average particle size of from about 1 nanometer to about 100 microns.

2. The powder selected from the group consisting of metal, alloys, and combinations thereof according to claim 1 having a passivation layer wherein said powders have reduced susceptibility to pyrophoric reactions.

3. The carbon powder according to claim 1 wherein a metal coating is deposited on the surface of said carbon powders to increase conductivity of said nanocomposite.

4. The nanocomposite according to claim 1 wherein said nanocomposite is mixed with a conductive filler selected from the group consisting of conductive polymers, metallic coated glass beads, and metallic coated glass fibers.

5. The powders selected from the group consisting of carbon, metals, metal oxides, alloys, and combinations thereof according to claim 1 wherein said powders are functionalized to improve dispersion, to improve conductivity, or to reduce interfacial tension.

6. The functionalized powders according to claim (c-1) are functionalized for at least one purpose selected from the group promoting dispersion, enhancing corrosion resistance, reducing friction, enhancing chemical stability, enhancing molecular polarity, modifying hydrophobic or hydrophilic characteristics, enhancing solubility, providing stability against thermal and ultraviolet degradation, enhancing lubricity, improving mold release, varying color, incorporating nucleating agents, enhancing plasticity, or enhancing means to make emulsions.

7. The nanocomposite according to claim 1 is further comprised of surfactant wherein the interfacial tension of the powders is reduced.

8. The nanocomposite according to claim 1 is further comprised of quantum dots wherein the flow of electrons is further enhanced by reducing the mean path length between said powders according to claim 1.

9. The powders selected from group consisting of metals, metal oxides, alloys, and combinations thereof according to claim 1 and metal coating according to claim 3 is further subjected to microetching process wherein the surface topography is modified with nanoscale dendritic features.

10. The powders selected from the group consisting of metals, and metal oxides according to claim 1 are further selected from the group of at least one metal from Au, Ag, Pd, Pt, Cu, Ni. Fe, Co, Be, Mo, Si, Tn, Sn, Al, and In; and the carbon powders according to claim 1 are further selected from at least one powder from the group of graphite, carbon nanotubes, diamond, fullerene carbons of the general formula (C₂)ₙ, where n is an integer of at least 30, or blends thereof.

11. An enhanced conductivity nanocomposite comprising:
a powder selected from the group consisting of metals, metal oxides, metal salts, alloys, and combinations thereof, the powder having an average particle size of from about 1 nanometer to about 100 microns;
a carbon powder wherein the powder having an average particle size of from about 1 nanometer to about 100 microns; and
a coating on the powder, the coating including at least one chemical agent selected from the group consisting of organic corrosion inhibitors, inorganic corrosion inhibitors, ethylene oxide/polypropylene oxide block copolymers, surfactants, lignin, lignin derivatives, alkali metal salts, alkali earth metal salts, ammonium salts, alkyl ether phosphates, and combinations thereof.

12. A nanocomposite comprising of:
a powder selected from the group consisting of metals, metal oxides, alloys, and combinations thereof, the powder having an average particle size of from about 1 nanometer to about 100 nanometers; and
a carbon powder wherein the powder having an average particle size of from about 1 nanometer to about 100 nanometers;
whereby the said powders are manufactured by the process steps of:
carbon is derived from graphite flakes subjected to graphite intercalation;
metals, metal oxides, alloys, and combinations thereof are derived from solubilized metal compounds;
graphite intercalation compound is formed by said carbon and metal compounds; and
said graphite intercalation compound is vaporized.

13. The metal compounds according to claim 12 is preferably selected from the group of copper, nickel, gold, and silver; and compounded preferably from the group of ammonia, and sulfuric acid.

14. The metal compound according to claim 12 is further comprised of at least one chemical agent selected from the group consisting of organic corrosion inhibitors, inorganic corrosion inhibitors, ethylene oxide/polypropylene oxide block copolymers, surfactants, lignin, lignin derivatives, ammonium salts, alkyl ether phosphates, and combinations thereof.

15. The chemical agent according to claim 15 is selected from the group of organic compounds comprised of only carbon, nitrogen, and hydrogen.

16. The chemical agent according to claim 15 is selected from the group consisting of azoles, benzotriazole, tolytriazole, halogen resistant azoles, and substituted derivatives thereof.

17. A heat exchanger comprising a polymer matrix and said nanocomposite according to claims 1, 11, and 12.

18. A heat exchanger comprising a heat transfer fluid and additive of said nanocomposite according to claim 1, 11, and 12.

19. A heat exchanger comprising a coating of said nanocomposite according to claim 1, 11, and 12.

20. A electrically conductive media comprising a matrix of conductive carrier and said nanocomposite according to claims 1, 11, and 12.
